(19) United States
(12) Patent Application Publication
(10) Pub. No.: US 2004/0007975 A1
(43) Pub. Date: Jan. 15, 2004

(54) Barrier rib structure for plasma display panel

(76) Inventors: Hsu-Pin Kao, Ping Chen City (TW); Meng-Hsuan Lin, Taipei (TW); Sheng-Chi Lee, Taipei (TW); Ching-Hui Lin, Taoyuan (TW)

Correspondence Address: HARNESS, DICKEY & PIERCE, P.L.C., P.O. BOX 828, BLOOMFIELD HILLS, MI, 48303, US

(21) Appl. No.: 10/191,872

(22) Filed: Jul. 9, 2002

(51) Int. Cl. H01J 17/49

(52) U.S. Cl. 313/582

(57) ABSTRACT

A barrier rib structure for a plasma display panel is described. According to the present invention, horizontal barrier ribs having different widths are located parallel to each other. A plurality of perpendicular barrier ribs is used to divide adjacent horizontal barrier ribs into a plurality of discharge spaces. The different width horizontal barrier ribs cause different heights for horizontal barrier ribs during the sintering process. Therefore, gas passages are formed between the barrier ribs and the upper substrate when the upper and the down substrate are sealed together.

### FIELD OF THE INVENTION

The present invention relates to a plasma display panel (PDP), and more particularly to a barrier rib structure for a plasma display panel.

### BACKGROUND OF THE INVENTION

Plasma display panels (PDP) can be divided into two types, the direct current (DC) type and the alternating current (AC) type, according to their electrical driving mode. In FIG. 1, which illustrates a conventional AC-type PDP, glass plates 11, 12 undergo several manufacturing steps in which many functional layers are formed thereon and are then combined together by sealing the periphery of the glass plates 11, 12. A mixed gas with a predetermined ratio is then introduced into the discharge units between the glass plates 11, 12.

In FIG. 1, a plurality of parallel transparent electrodes 111 and bus electrodes 112, a dielectric layer 113 and a protective layer 114 arc sequentially formed on the glass plate 11, hereinafter referred to as front plate 11. Similarly, a plurality of parallel address electrodes 121, a plurality of parallel barrier ribs 122, a fluorescencer 123 and a dielectric layer 124 are formed on the glass plate 12, hereinafter referred to as back plate 12. One transparent electrode 111 on the front plate 11 and one address electrode 121 on the back plate 12, transparent electrode 111 and address electrode 121 being perpendicularly crossed, comprise a discharge unit. When a voltage is applied to a specific discharge unit, gas discharge occurs at the discharge unit between the dielectric layers 113 and 124 to induce emission of a colored visible light from the fluorescencer 123.

FIG. 2 is a schematic, cross-sectional view corresponding to FIG. 1. In a conventional AC-type PDP 10, referring to FIGS. 1 and 2 simultaneously, a plurality of parallel-arranged transparent electrodes 111 are formed on the front plate 11. Each of the transparent electrodes 111 correspondingly has a bus electrode 112 to reduce linear resistance of the transparent electrodes 111. In one discharge unit 13, a three-electrode structure, including an X electrode and an Y electrode of the transparent electrode 111 on the front plate 11 and an address electrode 121 on the back plate 12, is generally employed. When a voltage is applied to the above three electrodes of a specific discharge unit 13 to induce discharge, the mixed gas in the discharge unit 13 emits ultraviolet (UV) rays to light the fluorescencer 123 inside the discharge unit 13. The fluorescencer 123 then emits a visible light, such as a red (R), green (G) or blue (B) light. An image is thus produced by scanning the discharge unit array.

In the conventional AC-type PDP 10, the barrier ribs 122 are arranged in parallel strips on the back plate 12. The address electrode 121 between two adjacent barrier ribs 122 is disposed inside the dielectric layer 124. In the structure, the fluorescencer 123 can only be coated on the sidewalls of the barrier ribs 122 and the top surface of the dielectric layer 124, so that only three planes are utilized. In each discharge unit 13, the fluorescencer 123 is coated on a small surface area, so that a low luminescence efficiency is obtained in the conventional PDP 10.

Since an erroneous discharge may occur in a non-discharge unit 13a, illustrated in FIG. 3, of the conventional AC-type PDP 10, the distance d between two adjacent discharge units 13 must be increased to prevent the same. Although a larger non-discharge unit 13a prevents erroneous discharge, discharge units 13 are then relatively contracted, i.e. have a reduced opening ratio, and luminescence efficiency is thus decreased. Conversely, a smaller non-discharge unit 13a provides larger discharge units 13, but erroneous discharge then readily occurs, so that neighboring discharge units 13 are affected during operation.

In addition, no isolation is provided between the discharge region A and non-discharge region B and erroneous discharge thus readily occurs in the non-discharge region B. A conventional method for solving the erroneous discharge issue in non-discharge region B is to perform an additional treatment of forming black strips to shade a light produced in the non-discharge region B. The contrast of the conventional PDP 10 is therefore increased, but further manufacture cost is incurred.

To solve the foregoing described problems, several different kinds of barrier rib structure have been developed by PDP designers and manufacturers. For example, a Waffle structure having sealed latticed barrier ribs has been provided as shown in FIG. 4. This structure uses barrier rib to isolate the discharge region A and the non-discharge region B. The discharge region A is a closed space according to this structure. Therefore, the problem of erroneous discharge occurring in the non-discharge region B is solved. On the other hand, the fluorescencer can be coated on the five planes of each discharge unit, i.e. front, back, left, right and bottom planes, thereby improving luminescence efficiency by increasing the fluorescencer coating area. However, because the vacuuming and gas refilling steps are performed between the discharge region A and non-discharge region B after the front and back glass plates of the PDP are adhered to each other, the closed discharge and non-discharge regions results in greater difficulties during performance of the two steps. Even though the two steps may be finished, the process time of the two steps increases due to the structure. To avoid the above problem, the front plate requires a new design to form a height difference in the surface of the front plate, so that some gas channels are formed after the front and back glass plates of the PDP are adhered to each other. The vacuuming and refilling gas steps is improved through these gas channels. However, the structure requires redesign of the front plate, which increases manufacturing difficulties.

### SUMMARY OF THE INVENTION

According to the above descriptions, the barrier rib structure of a conventional PDP has many drawbacks; for example, the structure is prone to erroneous discharge, the luminescence efficiency is low, or the structure is hard to vacuum. Therefore, the present invention provides a barrier rib structure for a plasma display panel (PDP) that can resolve above problems.

It is an object of the present invention to provide a barrier rib structure. In accordance with the present invention, the structure of each barrier rib arranged in a horizontal direction on the back plate is designed to form different widths. The different width structure causes different contractibility during the sintering process. The different contractibility forms height differences for each barrier rib, so that some gas channels are formed after the front and back glass plates of the PDP are adhered to each other. These gas channels are helpful to gas purging and refilling between the discharge and non-discharge regions during manufacture of a PDP device.

It is another object of the present invention to provide a barrier rib structure that forms an almost closed discharge space to constrict energy in the discharge space as well as gas discharge, and this structure is helpful in utilizing gas discharge energy. Furthermore, the structure may inhibit unsuitable discharges in non-discharge regions during gas discharging to prevent erroneous discharge to increase the luminescence efficiency.

accordance with the structure of the present invention, a plurality of barrier ribs having different widths are arranged in a horizontal direction and parallel to each other. A plurality of barrier ribs arranged in a perpendicular direction are used to divide adjacent horizontal barrier ribs into a plurality of discharge spaces. The structure of the different widths of each barrier rib may cause different contractibility during the sintering process. The different contractibility forms height differences for each barrier rib, so that some gas channels are formed to connect the discharge spaces after the front and back glass plates of the PDP are adhered to each other. These gas channels are helpful to gas purging and refilling between the discharge and non-discharge regions during manufacture of a PDP device. Furthermore, the almost-closed discharge space constrict energy in the discharge space as well as assisting gas discharge, and this structure is helpful in utilizing gas discharge energy. Compared with the conventional strip barrier rib structure, there are nine fluorescencer coating areas of each discharge unit in accordance with the barrier rib structure of the present invention. Accordingly, the total fluorescencer coating area of each discharge unit is increased, and thus the luminescence efficiency is improved.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic assembly diagram of a front substrate and a back substrate of a conventional plasma display panel;

FIG. 2 is a schematic, cross-sectional view of a conventional plasma display panel;

FIG. 3 is a schematic top view of a conventional plasma display panel in the state of erroneous discharge in a non-discharge region;

FIG. 4 is a schematic top view of a conventional plasma display panel having a Waffle structure discharge spaces;

FIG. 5 is schematic assembly diagram of a plasma display panel according to one preferred embodiment of the present invention;

FIG. 6 is a schematic top view of a barrier rib structure on a back substrate according to one preferred embodiment of the present invention;

FIG. 7 is a schematic top view of a barrier rib structure coordinated with X and Y electrodes on a front substrate according to one preferred embodiment of the present invention;

FIG. 8 is a schematic cross section view from the ZZ′ plane shown in the FIG. 7 according to one preferred embodiment of the present invention.

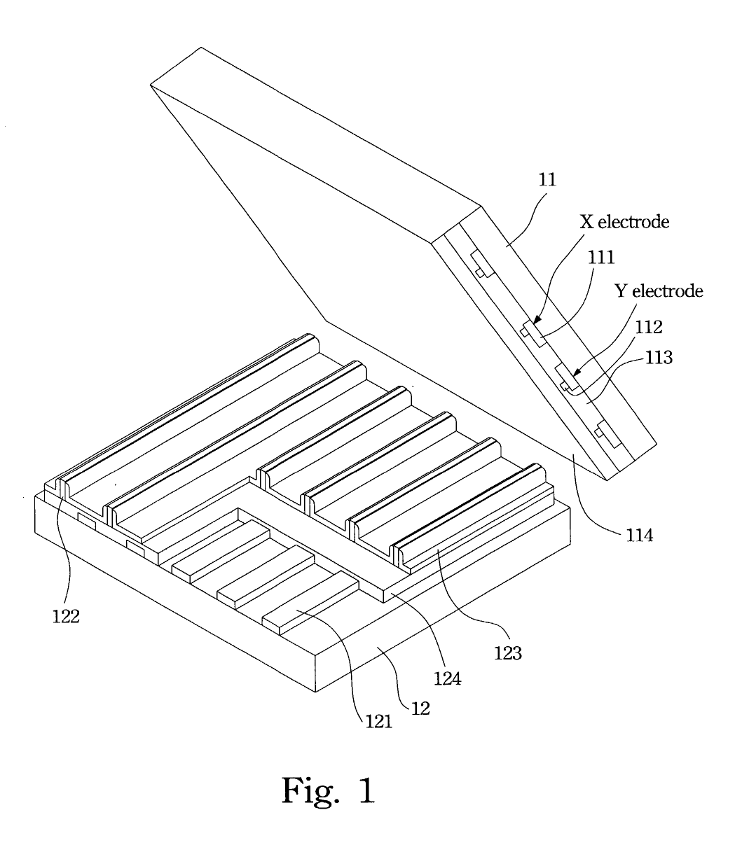

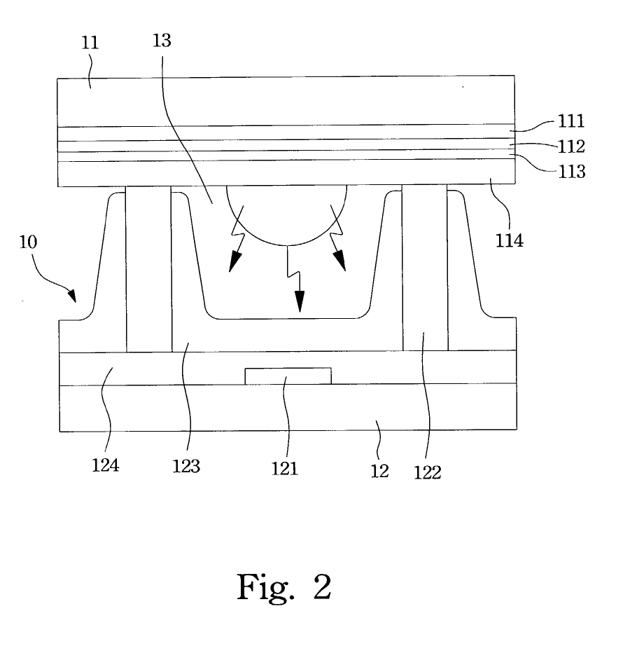

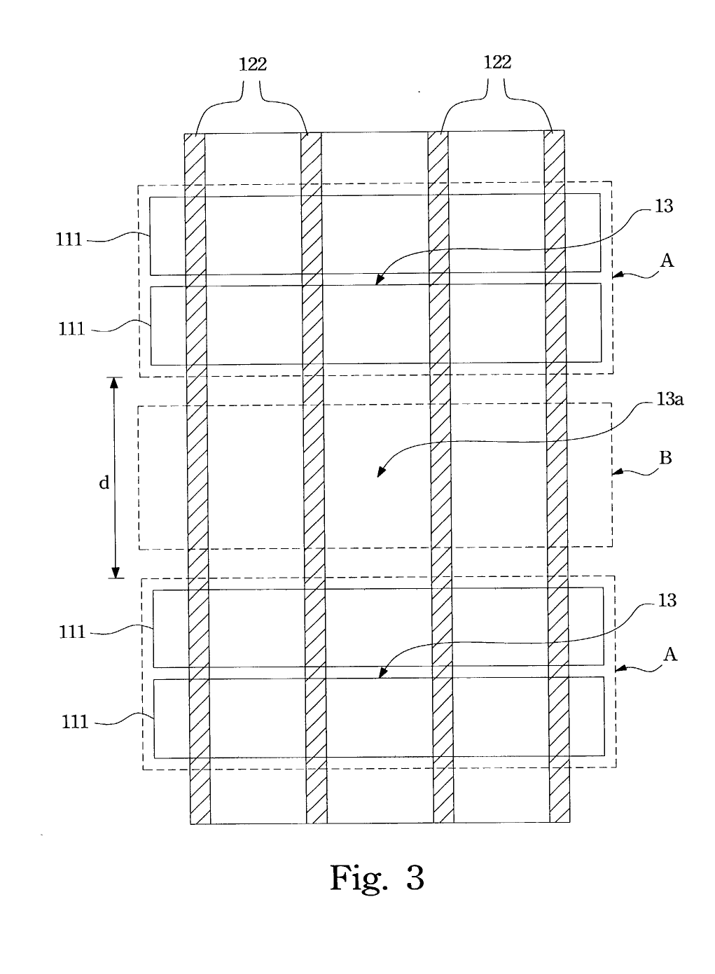

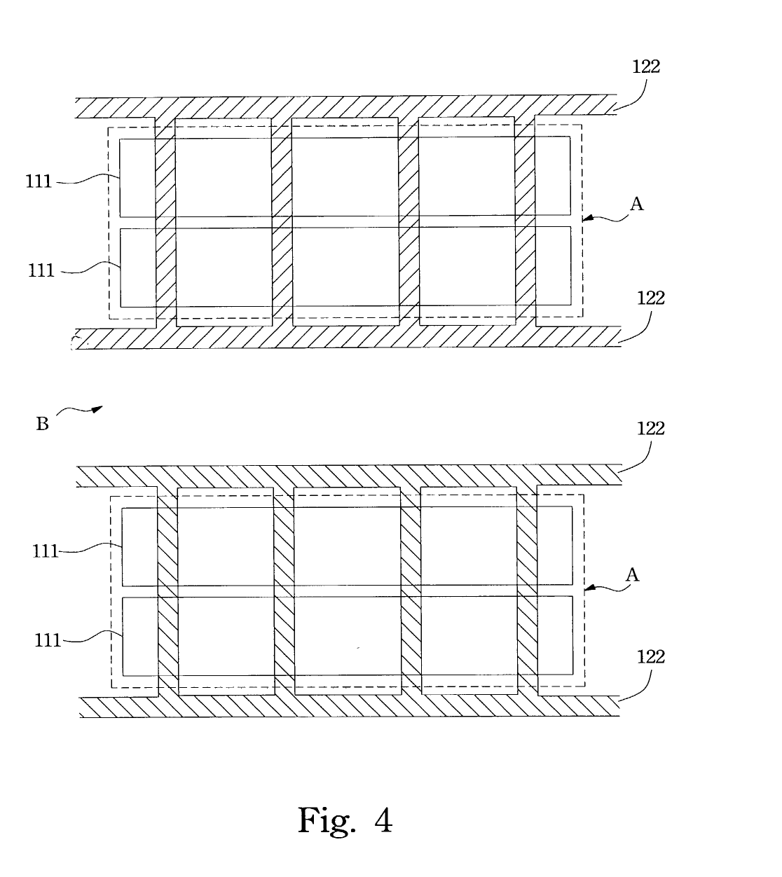

### DETAILED DESCRIPTION OF THE PREFERRED EMBODIMENT

Without limiting the spirit and scope of the present invention, the structure of barrier ribs in a plasma display panels (PDP) proposed in the present invention is illustrated with one preferred embodiment. Skilled artisans, upon acknowledging the embodiments, can apply the barrier rib structure of the present invention to any kind of plasma display panels to increase the fluorescencer coating area of each discharge unit. Furthermore, the structure of each barrier rib arranged in a horizontal direction on the back plate is designed to form different widths. The different width structure may cause different contractibilities during the sintering process. The different contractibilities form height differences for each barrier rib, so that some gas channels are formed after the front and back glass plates of the PDP are adhered to each other. These gas channels are helpful to gas purging and refilling between the discharge and non-discharge regions during manufacture of a PDP device. Therefore, the barrier rib structure not only solves the erroneous discharge problem but also improves the luminescence efficiency while not increasing the process time of gas purging and refilling.

The present invention provides a barrier rib structure for a plasma display panel. The barrier rib structure of the present invention is designed to form lattice structure. This kind of lattice structure not only increases the fluorescencer coating area of each discharge unit to improve luminescence efficiency, from three planes according to the conventional strip barrier rib to nine planes according to the present invention, but also avoids erroneous discharge occurring in the non-discharge region due to the discharge region being an almost-closed space. Furthermore, the barrier ribs arranged in the horizontal direction are designed to form different widths. The corner portions of each discharge unit having a lattice structure are formed by the wider barrier rib. The height differences are formed by the different width barrier rib forming different contractibilities during the sintering process. Therefore, some gas channels are formed after the front and back plates of the PDP are adhered to each other to improve the gas purging and refilling process.

According to the above description, the structure of the present invention does not require redesign of the front plate, so it is not necessary to increase the manufacturing cost. Furthermore, the portion of the wider barrier rib strengthens the structure. On the other hand, the barrier rib structure of the present invention forms an almost-closed discharge space to constrict energy in the discharge space during gas discharge. Therefore, the structure may inhibit unsuitable discharges in non-discharge regions during gas discharging to prevent erroneous discharge and increase the luminescence efficiency.

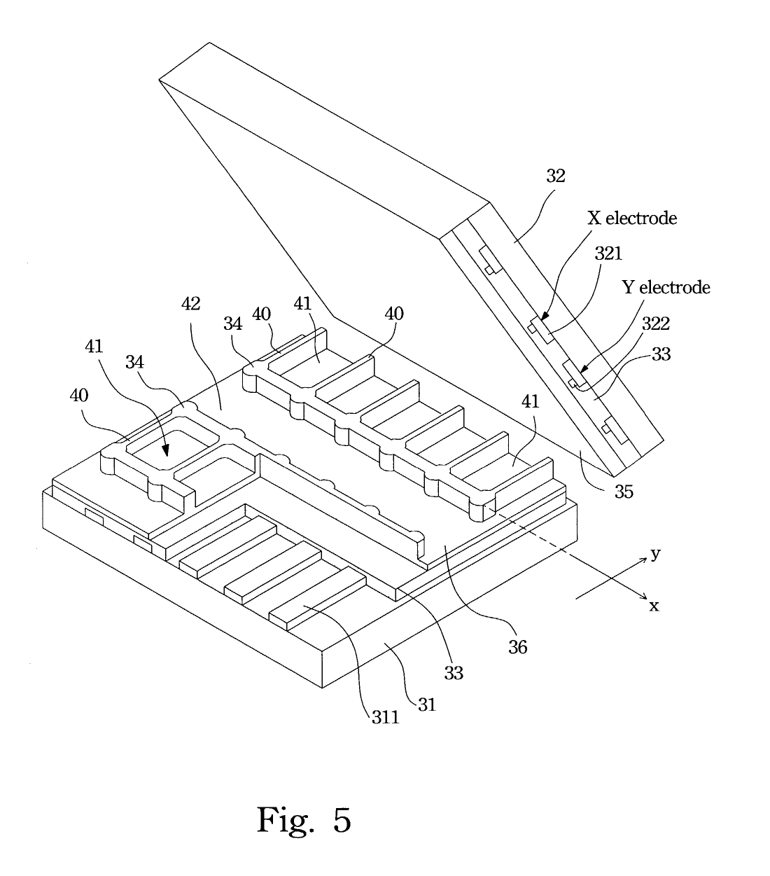

FIG. 5 is a schematic assembly diagram of a plasma display panel according to one preferred embodiment of the present invention. The plasma display panel (PDP) of the present invention at least comprises a front substrate 32 and a back substrate 31. A plurality of address electrodes 311 arranged in a perpendicular direction (y direction as shown in the figure) and parallel to each other are formed on the back substrate 31, and a dielectric layer 33 is formed on the back substrate 31 to cover the address electrodes 311. A plurality of barrier ribs 34 arranged in a horizontal direction (x direction as shown in the figure) and parallel to each other are formed on the dielectric layer 33. Each barrier rib 34 is designed to form a different width.

On the other hand, a plurality of barrier ribs 40 arranged in a perpendicular direction (y direction) are used to respectively connect the wider portion of the adjacent horizontal barrier ribs 34 into a plurality of discharge spaces 41 having a lattice structure. The corner portions of each discharge space 41 are formed by the wider portion of the barrier ribs 34. The non-discharge region 41 is formed between the adjacent discharge spaces 41 that are formed by the adjacent horizontal barrier ribs 34. That is, the discharge spaces 41 are adjacent and connected to each other in the horizontal direction (x direction). The non-discharge region 42 is used to isolate the discharge spaces 41 in the perpendicular direction (y direction). On the other hand, barrier ribs do not exist in the non-discharge region 42 in the horizontal direction (x direction). Therefore, the non-discharge region 42 may be used as the gas channels during purging and refilling process. Furthermore, a plurality of barrier ribs 40 arranged in the perpendicular direction (y direction) which are respectively located between the address electrodes 311 are formed on the dielectric layer 33, so that there is one address electrode 311 between two adjacent barrier ribs 40.

On the inside surface of the front substrate 32, a plurality of parallel-arranged transparent electrodes 321, including an X electrode and an Y electrode, is formed. Each transparent electrode 321 has a bus electrode 322 thereon. A dielectric layer 33 is formed on the front substrate 32 to cover the transparent electrodes 321 and bus electrodes 322. A protective layer 35 is formed on the dielectric layer 33. When the substrates 31, 32 are combined together and the steps of vacuuming and refilling with mixed gas having a determined mixed ratio of special gas, such as He, Ne, Ar, or Xe, are completed, the address electrodes 311 on the back substrate 31 and the transparent electrodes 321 on the front substrate 32 are perpendicularly crossed to form the corresponding discharge units.

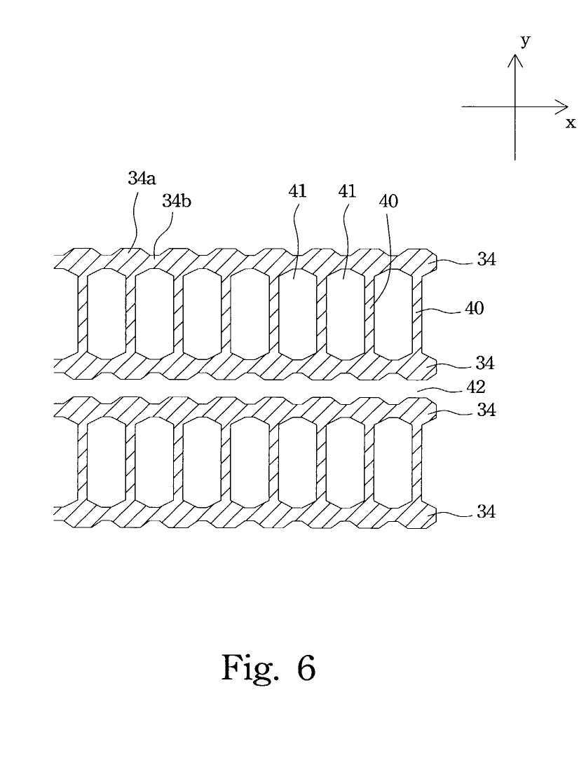

FIG. 6, is a schematic top view of a barrier rib structure on a back substrate 31 according to one preferred embodiment of the present invention. On the inside surface of the back substrate 31, a plurality of barrier ribs 34 are arranged in the horizontal direction (x direction) and parallel to each other. The structure of each barrier rib 34 comprises different widths, wide section 34a and narrow section 34b. These barrier ribs 34 and the address electrodes 311 are perpendicular to each other. A plurality of barrier ribs 40 arranged in a perpendicular direction (y direction) are used to connect with the wide section 34a to divide any adjacent horizontal barrier ribs 34 into a plurality of discharge spaces 41. The corner portions of each discharge space 41 are formed by the wide section 34a of the barrier ribs 34. These barrier ribs 40 arranged in a perpendicular direction and the address electrodes are in an alternating parallel arrangement, i.e. one address electrode 311 is located between two adjacent barrier ribs 34, as shown in FIG. 5. The non-discharge region 42 is used to isolate the discharge spaces 41 in the perpendicular direction (y direction). In other words, barrier ribs do not exist in the non-discharge region 42 in the horizontal direction (x direction). Therefore, the non-discharge region 42 may be used as the gas channels during purging and refilling process.

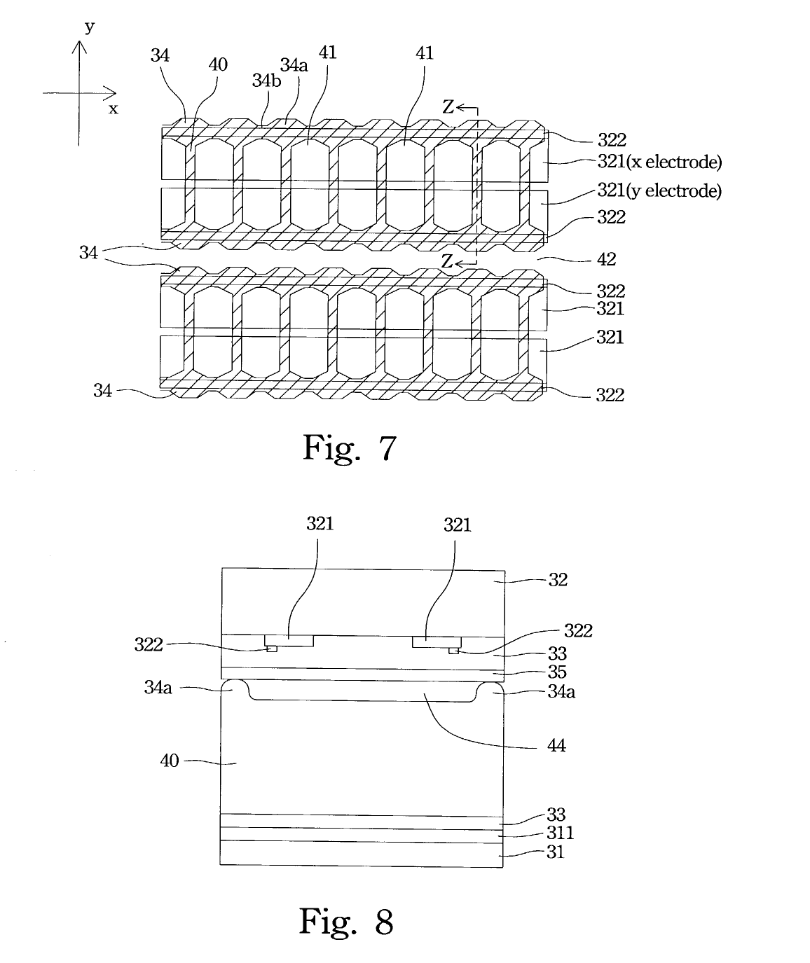

FIG. 7 is a schematic top view of a barrier rib structure coordinated with X and Y electrodes on a front substrate according to one preferred embodiment of the present invention. One is a discharge region where the regions of the transparent electrodes 321 (including X electrode and Y electrode) are located, and the other is a non-discharge region 42 between the discharge regions. Each transparent electrode 321 has a bus electrode 322 thereon. The structure of each barrier rib comprises different widths. Furthermore, these barrier ribs are arranged in a horizontal direction (x direction) and parallel to each other. A plurality of barrier ribs 40 arranged in a perpendicular direction (y direction) are used to divide adjacent horizontal barrier ribs 34 into a plurality of discharge spaces 41. These discharge spaces 41 are isolated from each other. This means that there is no gas channel between these discharge spaces. Therefore, almost closed discharge spaces 41 constrict energy in the discharge spaces 41 as well as gas discharge, and this structure is helpful in utilizing gas discharge energy. In other words, the structure may inhibit unsuitable discharges in non-discharge regions 42 during gas discharge to prevent erroneous discharge to increase the luminescence efficiency. Furthermore, because erroneous discharge does not occur, the width of the non-discharge region 42 can be reduced to enlarge relatively the size of the discharge spaces 41 in the discharge region, and the opening ratio is thus increased.

However, the structure described above results in the following problem. Because the vacuuming and refilling gas steps are performed between this structure after the front and back glass plates of the PDP are adhered to each other, the closed discharge spaces 41 result in greater difficulties when performing the two steps. Even if the two steps are finished, the process time of the two steps increases due to this structure. To avoid these problems, the structure of each barrier rib 34 according to the present invention is designed to comprise different widths, wide section 34a and narrow section 34b. The ratio of the narrow section 34b to the wide section 34a in accordance with the present invention is between 0.25 and 0.85, that is,

0.25≦narrow section 34b/the wide section 34a≦0.85

The structure of different width of each barrier rib 34 may cause different contractibility during the sintering process. The different contractibility forms the height difference between the narrow section 34b and the wide section 34a, in which the height of the wide section 34a is higher than the narrow section 34b. In accordance with the preferred embodiment, the temperature of the sinter process is about 550° C. and the height difference is between about 3 μm and 15 μm.

FIG. 8 is a schematic cross-sectional view from the ZZ′ plane shown in FIG. 7 according to one preferred embodiment of the present invention. Because of the height difference between the wide section 34a and narrow section 34b, the front plate 32 is only adhered to the wide section 34a after the front and back glass plates are adhered to each other. Gas channels 44 are formed among the narrow section 34b of the barrier ribs 34, the barrier ribs 40 arranged in a perpendicular direction and the front plate 32. These gas channels are helpful for performing the vacuuming and refilling gas process. In other words, the structure of the barrier ribs in accordance with the present invention does not require redesign of the front plate; therefore, the present invention can use the conventional front plate 32. In accordance with the preferred embodiment, because the discharge spaces 41 are adjacent to each other in the horizontal direction (x direction), these gas channels 44 respectively located between the front plate 32 and the corresponding barrier rib 40 join the adjacent discharge spaces 41.

On the other hand, referring to FIG. 7 again, the non-discharge region 42 is used to isolate the discharge spaces 41 in the perpendicular direction (y direction). Barrier ribs do not exist in the non-discharge region 42 in the horizontal direction (x direction). The gas channels 44 respectively located between the front plate 32 and the corresponding narrow section 34b of the barrier rib 34 may join the discharge spaces 41 and the non-discharge region 42 together. Therefore, in accordance with the structure design of the present invention, after the front plate 31 and back plate 32 are adhered to each other, these gas channels 44 may join the discharge spaces 41 and the non-discharge region 42 together. It is helpful to gas purging and refilling process. On the other hand, those almost closed discharge spaces 41 may constrict energy in the discharge spaces 41 as well as gas discharge, and this structure is helpful in utilizing gas discharge energy. In other words, the structure may inhibit unsuitable discharges in non-discharge regions 42 during gas discharging to prevent erroneous discharge to increase the luminescence efficiency. Furthermore, because erroneous discharge does not occur, the width of the non-discharge region 42 can be reduced to enlarge relatively the size of the discharge spaces 41 in the discharge region.

In accordance with the preferred embodiment of the present invention, the structure of each discharge space 41 is similar to an octagon. The gas channels 44 may join the discharge spaces 41 and non-discharge region 41 together. Therefore, this structure may increase the fluorescencer coating area of each discharge space 41 to improve luminescence efficiency, from three planes, including one bottom and two side wall planes, according to the conventional strip barrier rib to nine planes planes, including one bottom and eight side wall, according to the present invention. Reference is made to FIGS. 7 and 8 again. When a voltage is applied to the transparent electrodes 321 and address electrodes 311, gas discharge occurs in the discharge space 41 through the dielectric layers 33 on the front substrate 32 and back substrate 31 to generate ultraviolet rays from the mixed gas sealed therein. The ultraviolet rays light the fluorescent layer inside the discharge space 41 to produce colored lights, such as a red, green, or blue visible light. Therefore, the luminescence efficiency is increased by increasing the fluorescencer coating area.

On the other hand, the barrier ribs 34 arranged in the horizontal direction are designed to form different widths. The corner portions of each discharge space are formed by the wide section 34a of the barrier ribs 34. This is helpful for structural strength. Further, during the process of fabricating the barrier ribs 34, the adhesion of the photosensitive material layer to the barrier ribs 34 is enhanced because cling area is increased, so peeling of the photosensitive material layer does not occur and the yield of the product can be improved.

Accordingly, the present invention provides a barrier rib structure having different width for a plasma display panel. The structure of each barrier rib arranged in a horizontal direction is designed to form different widths. The different width structure may cause different contractibilities during the sintering process. The different contractibilities form the height differences for each barrier rib, so that some gas channels are formed after the front and back glass plates of the PDP are adhered to each other. These gas channels are helpful to gas purging and refilling between the discharge and non-discharge regions during manufacture of a PDP device.

Additionally, the barrier rib structure of the present invention forms an almost closed discharge space to constrict energy in the discharge space as well as gas discharge, and this structure is helpful in utilizing gas discharge energy. Furthermore, the structure may inhibit unsuitable discharges in non-discharge regions during gas discharging to prevent erroneous discharge to increase the luminescence efficiency.

As will be understood by a person skilled in the art, the foregoing preferred embodiments of the present invention are illustrative of the present invention rather than limiting of the present invention. They are intended to cover various modifications and similar arrangements included within the spirit and scope of the appended claims, the scope of which should be accorded the broadest interpretation so as to encompass all such modifications and similar structure.

What is claimed is:

1. A barrier rib unit for a plasma display panel formed on the inside surface of the back plate, wherein a plurality of barrier rib units are arranged in a first direction, parallel to each other and equidistant from each other comprise the barrier rib structure of a plasma display panel, said barrier rib unit comprising:
first and second barrier ribs arranged in the first direction and parallel to each other, wherein said first and second barrier ribs both are formed by a plurality of wide sections and narrow sections, and said wide section and said narrow section are alternatingly formed in the first direction, and a height difference exists between said wide section and said narrow section; and
a plurality of barrier ribs arranged in a second direction and parallel to each other and located between said first and second barrier ribs, wherein said plurality of barrier ribs are second with said first and second barrier ribs and respectively connect with said plurality of wide sections of said first and second barrier ribs to form a plurality of discharge spaces.

2. The barrier rib unit according to claim 1, wherein said first direction is perpendicular to said second direction.

3. The barrier rib unit according to claim 1, wherein a ratio of said narrow section to said wide section is about between 0.25 and 0.85.

4. The barrier rib unit according to claim 1, wherein each discharge space includes one bottom and eight side walls.

5. The barrier rib unit according to claim 1, wherein said height difference is between about 5 μm and 30 μm.

6. A gas discharge luminescent structure of a plasma display panel, comprising:
a back plate, wherein a plurality of address electrodes arranged secondin a second direction and parallel to each other are formed thereon;
a plurality of gas discharge luminescent units formed on the surface of the back plate, wherein said plurality of gas discharge luminescent units are arranged in a first direction, parallel to each other and equidistant from each other, each gas discharge luminescent unit comprising:
first and second barrier ribs arranged in the first direction and parallel to each other, wherein said first and second barrier ribs both are formed by a plurality of wide sections and narrow sections, and said wide section and said narrow section are alternatingly formed in the first direction, and a height difference exists between said wide section and said narrow section; and
a plurality of barrier ribs arranged in a second direction and parallel to each other and located between said first and second barrier ribs, wherein said plurality of barrier ribs is second to said first and second barrier ribs and respectively connect with said plurality of wide sections of said first and second barrier ribs to form a plurality of discharge spaces;
a fluorescent layer on side walls and bottom of said each discharge space; and
a front plate formed on said a plurality of discharge spaces, wherein a plurality of transparent electrodes arranged firstin a first direction and parallel to each other are formed therein, and said transparent electrodes cross said address electrodes over said plurality discharge spaces, respectively.

7. The gas discharge luminescent structure according to claim 6, wherein said first direction is perpendicular to said second direction.

8. The gas discharge luminescent structure according to claim 6, wherein a ratio of said narrow section to said wide section is about between 0.25 and 0.85.

9. The gas discharge luminescent structure according to claim 6, wherein each discharge space includes one bottom and eight side walls.

10. The gas discharge luminescent structure according to claim 6, wherein said height difference is between about 5 μm and 30 μm.

11. The gas discharge luminescent structure according to claim 6 further comprising a plurality of gas channels formed between said narrow section and said front plate.

12. A method for forming barrier rib unit having a height difference for a plasma display panel on the inside surface of the back plate, wherein a plurality of barrier rib units are arranged in a first direction, parallel to each other and equidistant from each other comprises a barrier rib structure of a plasma display panel, said method comprising:
forming first and second barrier ribs on said back plate, wherein said first and second barrier ribs are arranged in the first direction and parallel to each other, both barrier ribs are formed by a plurality of wide sections and narrow sections, and said wide section and said narrow section are alternatingly formed in the first direction;
forming a plurality of barrier ribs, wherein said plurality of barrier ribs are arranged in a second direction and parallel to each other and are located between said first and second barrier ribs, said plurality of barrier ribs are second to said first and second barrier ribs and respectively connect with said plurality of wide sections of said first and second barrier ribs to form a plurality of discharge spaces; and
performing a sintering process to form a height difference.

13. The method according to claim 12, wherein said first direction is perpendicular to said second direction.

14. The method according to claim 12, wherein a ratio of said narrow section to said wide section is about between 0.25 and 0.85.

15. The method according to claim 12, wherein said each discharge space includes one bottom and eight side walls.

16. The method according to claim 12, wherein said sintering process temperature is about 550° C.

17. The method according to claim 12, wherein said height difference is between about 5 μm and 30 μm.
